(19) United States
(12) Patent Application Publication
(10) Pub. No.: US 2020/0276081 A1
(43) Pub. Date: Sep. 3, 2020

(54) CONTAINER, CONNECTION AND PRODUCTION DEVICE

(71) Applicant: KOCHER-PLASTIK MASCHINENBAU GMBH, Sulzbach-Laufen (DE)

(72) Inventors: Johannes GESER, Gerlingen (DE); Roland SAUTER, Sulzbach-Laufen (DE); Daniel BOJBIC, Sulzbach-Laufen (DE); Sven SCHNEIDER, Abstgmuend (DE); Torsten GIEBELER, Gaildorf (DE)

(21) Appl. No.: 16/645,587

(22) PCT Filed: Sep. 18, 2018
(86) PCT No.: PCT/EP2018/075132

§ 371 Date: Mar. 9, 2020

(30) Foreign Application Priority Data
Sep. 26, 2017 (DE) 10 2017 009 012.2

(51) Int. Cl. A61J 1/06; A61J 1/14

(52) U.S. Cl. CPC A61J 1/067; A61J 1/1418

(57) ABSTRACT

A container, in particular an ampule, of a plastic material having a container part (10) for receiving the contents of a containers (14) dispensed via a container opening (12), which is closed by a head part (18) that can be separated along a separation line (16,) which is adjoined by a neck part (20), which has a plurality of different functional surfaces on the inner circumference, of which one functional contact surface (44) is used to seal against a withdrawal body (32), which is provided for withdrawing the contents of a container (14) when the container opening (12) is opened, wherein in addition to the existing functional surfaces a lead-in area (50) is provided as a further functional surface on the interior of the neck part (40), which differs geometrically from the functional contact surface (44), is characterized in that the lead-in area (50) seamlessly merges into the functional contact surface (44) and that the lead-in area (50) and the functional contact surface are located between the other functional surfaces (44) in the neck part (20).

The invention relates to a container, in particular an ampule, consisting of plastic material, having a container part for receiving the contents of a container dispensed via a container opening, which is closed by a head part that can be separated along a separation line, which is adjoined by a neck part, which has a plurality of different functional surfaces on the inner circumference, of which one functional contact surface is used to seal against a withdrawal body, which is provided for withdrawing the contents of a container when the container opening is opened, wherein in addition to the existing functional surfaces a further functional surface is provided in the form of a lead-in area on the interior of the neck part for a safe withdrawal and a consistent and reliable production, which further functional surface geometrically differs in at least one characteristic from the characteristic of the one functional contact surface.

Such containers, which can be connected to a withdrawal body of a withdrawal device for instance by means of a conical connection, such as a syringe, are regularly used for medical purposes are regularly used for medical purposes. The conical connection can be lockable (ISO 80369-7: 2016, for instance, a LuerLock connection) or non-lockable (ISO 80369-7: 2016, for instance a Luer-slip connection). These and other connection geometries and their variants, which are used for fluid withdrawal, for instance for enteral (ENFit, ISO 80369-3: 2016) or neuraxial (NRFit, ISO 80369-6: 2016) applications, are described in detail in the listed standards.

The preferred connections for parenteral purposes—for instance, hypodermic syringes—having a cone connection having a cone ratio of 6%, which corresponds to a cone angle of 3.43 degrees, are also referred to in technical language as Luer connections. These known connection geometries use relatively large sealing surfaces, which are used to establish the required secure seal between the elements to be connected over a relatively long conical area. Very good surface qualities are required to ensure the desired secure seal, for instance between injection syringe and injection needle. This can easily be achieved with injection-molded components using rigid and semi-rigid materials, for instance using plastics such as polycarbonate (PC), styrene acrylonitrile (SAN), polystyrene (PS), etc. This also results in low “joining forces” for the user. The connection of syringes as a withdrawal device having filled drug containers, however, is particularly challenging.

If a container is to be produced in a cost-effective manner in large quantities and using other plastic materials (polypropylene, polyethylene) as described above, for instance as part of a blow molding process, including preferably the blow molding, filling and closing processes, the occurrence of leaks or leakages during the withdrawal operation from the container by means of the withdrawal device cannot always be definitely ruled out, which may be associated with an undesired risk to the patient. Therefore, it is important to ensure a sufficient tightness of the withdrawal connection against the entry of possibly contaminated air into the interior of the container on the one hand and on the other hand against an unwanted seepage of fluid from the container.

With regard to the requirements explained above, for a generic container in accordance with US 2016/0200484 A1, in addition to the large conical primary sealing surface across the entire neck area (FIGS. 6 to 8), adding an additional secondary seal in the manner of a lip seal at an axial distance has accordingly been proposed, which lip seal opens into the environment after the head part has been severed thereby opening the container, and which rests against the withdrawal body of the withdrawal device as soon as the withdrawal body engages with the container.

Two further functional surfaces are arranged between the additional sealing lip at the top and the conical sealing surface at the bottom spaced apart from the former, of which the one, third functional surface merges into the conical-sealing surface via a conical inner ledge along a separating seam (FIG. 4). The further fourth functional surface adjoins this third functional surface, merges into the sealing lip and, to that extent, forms a cylindrical peripheral surface at the inner peripheral end of the neck part, which cylindrical peripheral surface is penetrated by the withdrawal body for a withdrawal process. This fourth functional surface in conjunction with the adjacent outer wall parts of the neck part forms two rectangular fixing webs widened in diameter, against the bottom end of which an additional circumferential container wall rests if the container is set up, forming a mounting for the withdrawal system at the outside. The third and fourth functional surfaces, which hold the primary and secondary seals (conical sealing surface and sealing lip) axially spaced apart from each other, comprise the withdrawal body penetrating the container at a radial distance and insofar do not perform a sealing function.

The implementation of a reproducible sealing lip as a secure secondary seal, however, appears difficult, because the thin sealing lip is formed only by the user removing the cap part. As a result, user-specific and handling-related irregularities of the sealing lip cannot be safely ruled out and their reproducible sealing function is thus questionable.

The required secondary seal naturally causes additional friction between the withdrawal body to be input and/or output and the neck area of the container, resulting in increased actuating or joining forces in establishing the fluid-conveying connection, which makes handling more difficult, especially if the operator wears the appropriate gloves for reasons of hygiene. In order to be able to safely transfer such increased handling and connection forces, in particular when inputting the withdrawal body, the wall thickness of the neck wall is particularly thick-walled in the area of the contact surface, so as to avoid kinking of the neck part in this area; however increased actuating forces are necessary to introduce the conical withdrawal body in this area of the neck part having an increased wall thickness by appropriate widening along the functional contact surface.

The two fixing webs diametrically opposite from each other in relation to the container longitudinal axis also form, on the outer circumference of the neck part, the option to clamp the withdrawal device having the withdrawal body accordingly for an open container to form a LuerLock connection; however, the disadvantageous arrangement of the two fixing webs in a common plane transverse to the longitudinal axis of the container frequently results in an over-winding of the locking thread of the withdrawal device, which significantly confuses the user, because he assumes a defect of the container.

Based on this prior art, the invention addresses the problem of providing an improved container in comparison with the known container and of providing a manufacturing device, which can be used to produce the container according to the invention in a safe and cost-effective manner.

A container having the features of patent claim 1 in its entirety and a manufacturing device having the features of claim 17 solve this problem. Further advantageous embodiments of the solutions according to the invention in accordance with the respective main claims are the subject of the dependent claims.

The container according to the invention is characterized in that a lead-in area in the manner of an additional functional surface seamlessly merges into the functional contact surface and that the lead-in area and the functional contact surface are located between the other functional surfaces in the neck part. The container according to the invention further stands out because the wall thickness in the area of the lead-in area, but in particular in the area of the functional contact surface, is markedly lower than the average wall thickness in the neck part. This results in the low radial stiffness of the sealing area (partial area of the functional contact surface depending on the individual geometry of the withdrawal body) decisive for secure sealing, because only low forces have to be applied for the latter's expansion by the withdrawal body. Moreover, according to the invention, a design of the functional contact surface, which is as short as possible in the axial direction, is advantageous in order to ensure that the ampule has sufficient torsional stability. This, in turn, is important for the ampule to be opened at the intended separation line and not in the area of the functional contact surface, which would render the container unusable. Moreover, the short design of the functional contact surface prevents buckling or snapping of the container in the neck area during the insertion of the withdrawal body. The term “lead-in area” is aimed at showing that it is located in front of the functional contact surface in the direction the withdrawal body is inserted into the container part. Furthermore, the container according to the invention is particularly preferably produced by means of a blow molding, filling and closing process, which has become known in the industry as the brand Bottelpack®.

The reduction of the length of the functional contact surface by the seamlessly adjacent lead-in area at the head permits a surprisingly secure seal and at the same time the force to produce the connection between the withdrawal body and container is reduced. Also, for reasons of a consistent and reliable production of blow-molded ampules, the short-surface pressure having an increased sealing force effect achieved by the invention is preferable to the known surface pressure, because geometric tolerances in the container neck are inherently compensated by the connection process. Thus, within a predefinable tolerance field, due to geometric deviations or deviations in the material structure, an effective seal results between the insides of the container neck part and the withdrawal body at locally high pressing force, but overall reduced total forces due to the reduction of the effective total sealing surface.

In a preferred embodiment of the container according to the invention provision is made that the mentioned differences in the characteristics between the functional contact surface and lead-in area to improve the insertion force of the withdrawal body and the sealing force effect are based on their
longitudinal extension and/or
wall thickness in conjunction with adjacent outer wall parts of the neck part and/or
the inclination of the surface

In this way, an actual sealing surface (part of the functional contact surface depending on the geometry of the withdrawal body) having a small width can be implemented, which does not reduce the stability of the neck part as a whole. Also, due to the small width and the low rigidity of the actual sealing area, the requirements for the angular tolerance of the functional contact surface are much lower, which results in particular in improved mass production capabilities if soft materials such as polypropylene (PP) or polyethylene (HDPE, LDPE) are used. In this way, the container according to the invention can be easily produced inexpensively in large quantities as part of a conventional blow molding, filling and closing process.

A radially elastic design of the container opening in the sealing surface area is achieved in particular by reducing the mean wall thickness of the lead-in area and/or functional contact surface in comparison to the mean wall thickness of the other functional surfaces by approx. 20%-50%, preferably 20%-30% by including the adjacent outer wall parts of the individual functional surfaces. That is, there is an overall reduction in wall thickness in the actual so-to-say sealing line area while still providing sufficient axial stiffness to prevent buckling, such that for low actuation forces a secure connection is established for the withdrawal of the contents of a container between the withdrawal body and container.

In a particularly preferred embodiment of the container according to the invention, the functional contact surface forms an abutment cone which has an opening angle of 3.43 degrees (cone angle) or greater relative to the longitudinal axis of the container, wherein the correspondingly determined opening angle of the lead-in area according to the invention is 30 degrees, respectively an oblique inclination of 15 degrees, that is half an opening angle. In particular, if the cone angle of the container in the area of its extraction point is greater than 3.43 degrees with respect to a cone angle of the withdrawal body, for instance in the form of a syringe, having a male cone part of 3.43 degrees or 6% in accordance with ISO 80369-7:2016 is selected, an interference-free connection process for the withdrawal body at low actuation forces and simultaneously very good fluid sealing is achieved. The opening angle of the additional conical lead-in area of 30 degrees is also a contributing factor; a value that on the one hand ensures a high line pressure between the functional contact surface and the withdrawal body and on the other hand forms an additional insertion aid in the sense of a conical extension for the free end face of the withdrawal body, to further facilitate the insertion process in the direction of the functional contact surface.

In a further preferred embodiment of the container according to the invention provision is made to equip it with further functional surfaces on the inside of the neck part to further brace the neck part, wherein one of the other functional surfaces at its adjacent outer wall part has a locking feature for the withdrawal body, preferably in the form of a threaded section, which is preferably formed of two partial threads. The mounting according to the invention ensures that no unintentional over-tightening can occur when the withdrawal device is screwed onto the withdrawal body, i.e. in any case a secure threaded engagement is realized, in which the sealing cone of a lockable connection is pressed into the counter seat in a sealing manner.

In a further preferred embodiment having a locking option (for instance a LuerLock connection), an increased spacing of more than 3 mm, preferably more than 4 mm, particularly preferably more than 5 mm is provided between the head end of the functional contact surface and the opening. In this way, during the connection process, the engagement with the partial thread is established first, before the sealing pressure is generated. This significantly improves handling for the user.

To be able to safely use withdrawal devices having withdrawal bodies of different lengths (only their minimum length is specified in the standard), it is also advantageous if, after the complete connection, the upper edge of the opened container does not axially abut the withdrawal device. This is achieved—in contrast to the arrangement shown in US 2016/0200484 A1—in that the spacing from the head end of the partial thread to the separation line (the upper edge of the opened ampule) is very small and not more than 2 mm, preferably less than 1 mm.

In a preferred embodiment of the container according to the invention provision is made that at least two webs extend over the functional contact surface and the lead-in area at their adjacent outer wall parts, which webs are preferably arranged diametrically to the longitudinal axis of the container opposite from each other, and that the free ends of the webs merge into the adjacent outer wall areas of the third and fourth functional surfaces and thus largely axially brace the relevant sealing area in the center of the neck part, and increase its section modulus of torsion against unwanted opening in the sealing area, but not significantly increase its radial stiffness.

Furthermore, it is the object of the invention to provide a device for producing such a container or such a connection device, wherein a forming mandrel is used as part of a plastic shaping manufacturing process, which, as a positive mold, maps at least two functional surfaces in the form of the functional contact surface and in the shape of the adjoining additional functional surface as set forth above.

It is particularly preferred in a manufacturing device that the forming mandrel be used in the production of a container, as stated above, as part of a blow molding, filling and closing process. For this purpose, the mandrel is designed as a hollow mandrel.

The solutions according to the invention will now be described in greater detail by way of exemplary embodiments shown in the drawing. In the figures, in general view, not to scale,

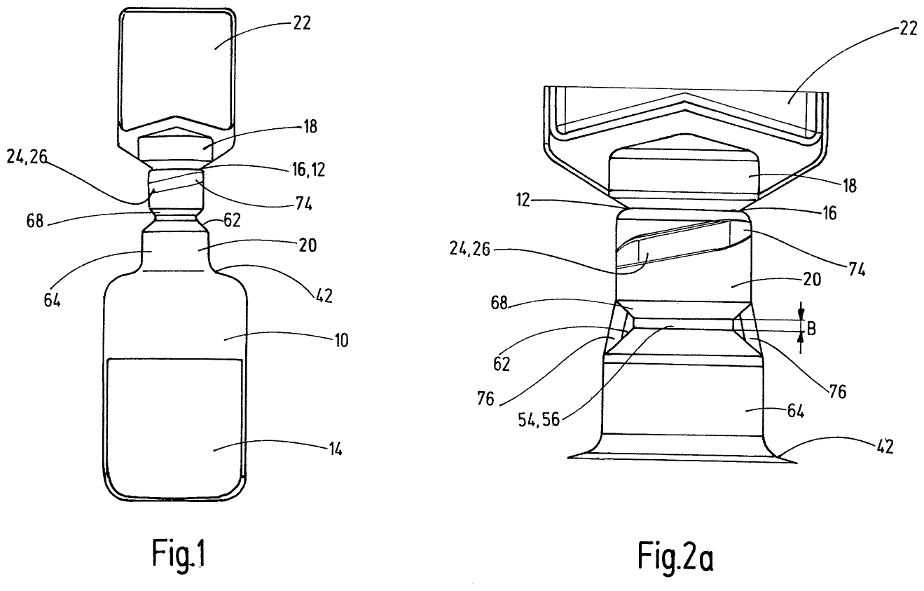

FIG. 1 shows an end view of a filled container in the manner of an ampule;

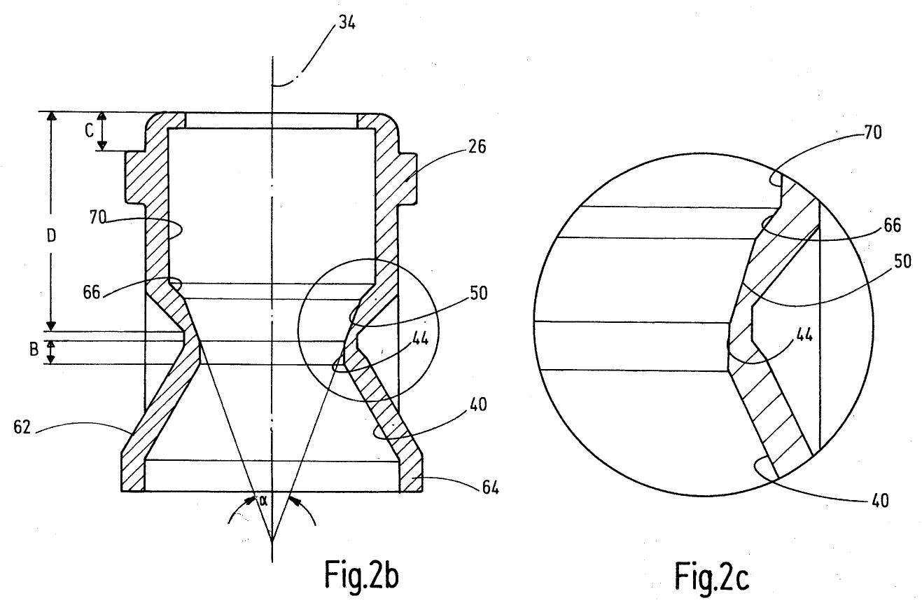

FIGS. 2a-c show an enlarged view of an upper part of the container of FIG. 1 before opening (FIG. 2a) and schematically a cross-section after opening (FIG. 2b) by removing the head part at the separation line (16), and (FIG. 2c) shows a partially enlarged view;

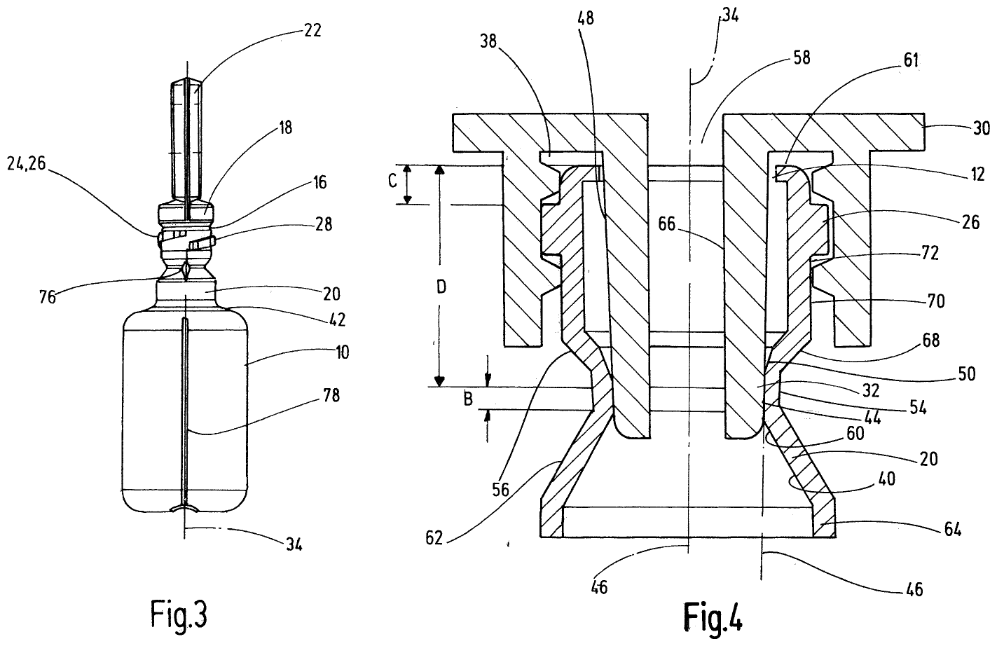

FIG. 3 shows a side view of the container according to FIG. 1;

FIG. 4 shows the connection area of the container according to the invention connected to a lockable conical connection in the manner of a partial longitudinal section; and

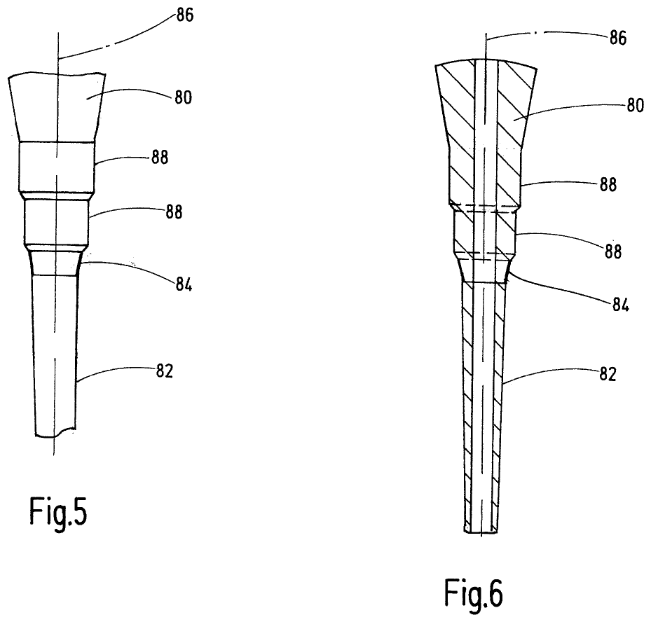

FIGS. 5 and 6 show a view and a longitudinal section, respectively, sections of a filling mandrel for producing a neck part and filling a container according to FIGS. 1 to 4.

FIG. 1 shows an integral container as a whole prior to its opening in the form of an ampule of plastic material comprising a container part 10 for receiving liquid or semi-solid the contents of a container 14 for medical purposes or the like that can be dispensed via a container opening 12. The mentioned container opening 12 is closed along a separation line 16 by a detachable head part 18, which is adjoined by a neck part 20, which merges into the actual container part 10. The head part 18 has a handle 22, which can be used to twist off the head part 18 from the neck part 20 at the separation line 16, thereby opening the container opening 12 using low actuating torques/forces. FIG. 2b shows a cross-section of an exposed container opening 12 after the head part 18 has been twisted off by means of the handle 22 by way of example.

On the outer circumference, in the upper part of the neck part 20, a part of a threaded section 24 is shown in the manner of a female thread, which in this case is formed of two partial thread sections 26, 28, one partial thread part 26 of which is located at the front of the neck part 20 as shown in FIGS. 1 and 2a and one partial thread section 28 of which is located in the rear as shown in the side view of FIG. 3. The mean thread profiles of the two partial thread sections 26, 28 form an angle of 70 to 80 degrees with the longitudinal axis 34 of the container in the area of their rear convergence as shown in FIG. 3. The threaded section 24 on the outer circumference of the neck part 20 is used to lock to a withdrawal device 30 having a tapered withdrawal body 32, as shown in part in FIG. 4 by way of example.

Such a withdrawal device 30 is for instance part of a syringe whose withdrawal body 32 is used to withdraw the contents of the container 14 from the container part 10 when the container opening 12 is opened.

As further shown in FIG. 2a-c and FIG. 4, a plurality of different functional surfaces are provided on the inside 40 of the neck part 18, wherein the neck part 20 adjoins a transition bend 42 at the upper end of the container part 10 and extends therefrom between the container part 10 up to the separation line 16, to which the head part 18 is attached. One of the functional surfaces mentioned forms a functional contact surface 44. A part of this functional contact surface 44 dependent on the individual detail geometry of the withdrawal body 32 is used to seal against the withdrawal body 32 of the respective withdrawal device 30. Fictitiously extending the peripheral functional contact surface 44 downwards, these extensions 46 form a cone angle of 3.43 degrees with each other and thus form a preferred port having a cone ratio of 6%. The outer wall 48 of the withdrawal body 32 tapering conically downwards has a corresponding inclination. If the withdrawal device 30 having the cone-shaped withdrawal body 32 is completely inserted along the neck part 20 (see FIG. 4), a part of the outer wall 48 is in sealing contact with at least part of the functional contact surface 44. According to the illustration of FIG. 4, the withdrawal device 30 is completely connected and a female thread 38 of the withdrawal device 30 is locked to the neck part 20 via the partial threads 26, 28. A free length tolerance compensation space 61 remains between the head end of the neck part 20 and the withdrawal device 30, which permits the safe use of withdrawal devices 30 having withdrawal bodies 58 of different lengths. According to the invention, this is achieved in that the spacing from the head end of the partial thread to the separation line (the upper edge of the opened ampule) is very small and not more than 2 mm in length, preferably less than 1 mm.

Viewed in the direction of FIG. 4, an additional functional surface, the lead-in area 50, is formed at the inside 40 of the neck part 20 above the functional contact surface 44. This additional functional surface 50 merges seamlessly into the functional contact surface 44, wherein the lead-in area 50 and the functional contact surface 44 are located in the neck part 20 between the other functional surfaces, which will be explained in more detail below. In particular, at least one characteristic of the lead-in area 50 differs from [that of] the functional contact surface 44 seamlessly adjoining at the end of the container body.

In any case, the individual difference in the characteristics between functional contact surface 44 and additional lead-in area 50 has to be used to ensure that an increased sealing pressure can act on the inserted withdrawal body 32 for a reduced sealing surface. On the one hand, provision is made in particular for the functional contact surface 44 to be designed having a small width B (see FIG. 4, but not to scale), where B is less than 3 mm, preferably less than 2 mm, particularly preferably less than 1 m.

Furthermore, provision is made that, taking into account the adjacent rotationally symmetrical outer wall part 54 of the functional contact surface 44 and the outer wall part 56 of the additional functional surface 50, the average wall thickness at least in a partial area of the functional contact surface 44 and/or a partial area of the lead-in area 50 is reduced by approximately 20%-50%, preferably approximately 20%-30%, with respect to the average wall thickness in area of the other functional surfaces 66, 70. This has to be based on a mean wall thickness, as at least the functional surfaces 44 and 50 have a corresponding inclination, whereas in particular according to the illustrations of FIGS. 1 to 3, the outer circumference of the outer wall parts 54, 56 is mainly cylindrical. The average wall thickness in the above-mentioned sealing area including the two functional surfaces 44, 50 is thus less than 4 mm, preferably less than 3 mm, particularly preferably less than 2 mm. This results in a very favorable elastic design of the container opening or ampule opening in said sealing area in the radial direction, due to a corresponding reduction in wall thickness. Thus, viewed in the axial longitudinal extent of the container body 10, in the neck part 20 a high axial stiffness is achieved to prevent any indentations during the insertion of/connection to the withdrawal body 32.

In a particularly preferred embodiment, however, provision is made for the similarly determined opening angle alpha of the additional lead-in area to be approximately 10 to 50 degrees, preferably 20-40 degrees, particularly preferably 30 degrees, relative to the contact cone of the peripheral contact surface 44. As a result, a tilt-safe insertion is possible, which can be done applying little force and without the formation of abrasion particles. This is very advantageous compared to the prior art (US 2016/0200484 A1), in which a sealing lip must be fitted for an improved seal at the free end area of the neck part.

Accordingly, in the solution according to the invention, a high local pressing force, a quasi-line pressing force, results in an improved seal, wherein, due to a reduced sealing surface, overall lower total forces are required to introduce the withdrawal device 30 having the withdrawal body 32 in its final withdrawal position in the neck part 20 of the container or the ampule. This is without parallel in the prior art.

In a further preferred embodiment having a locking option (for instance a LuerLock connection), an increased spacing D (see FIG. 4) of more than 3 mm, preferably more than 4 mm, particularly preferably more than 5 mm is provided between the head end of the functional contact surface 44 and the opening 12. In this way, during the connecting process first the partial threads engage before the sealing pressing between a part of the functional contact surface 44 and the withdrawal body is produced. This considerably facilitates the connection between the withdrawal device and the container.

For an improved sealing and an improved introduction of the withdrawal body 32, it may moreover be provided that in particular the functional contact surface 44 forms a contact cone, which opens an angle of more than 3.43 degrees with respect to the longitudinal axis 34 of the container (corresponding to a 6% cone ratio according to ISO 80369-7: 2016).

Surprisingly, it has been found that, despite different cone angles a secure sealing can be achieved between the—at 3.43 degrees standard—cone of the withdrawal body 32 and the container 10 according to the invention.

The radially elastic functional surfaces 44 and 50 having a small width B provide a quasi-linear sealing area, which is largely insensitive to geometric tolerances, surface damage and the like, thus rendering a pressure-tight usage of the container below and above atmospheric pressure possible.

As further shown in FIG. 4, there is a transition surface as a further third functional surface 60 on the inside 40 of the neck part 20, which opens into the container part 10 and, starting from the contact surface 44, has an outwardly projecting transition cone 62. Viewed downwards in the direction of FIG. 4, the transition cone 62 merges into a cylindrical transition piece 64, which integrally merges within the limits of the transition arc 42 as part of the neck part 20 into the container part 10, which is formed as a holding option within a predetermined hollow volume for the contents of a container 14. At the outer and inner peripheral ends in each case, the pertinent transition piece 64 is formed as a circular or oval hollow cylinder piece.

Viewed in the direction of view of FIG. 4, a further transition cone 68 is provided as a further fourth functional surface 66, adjacent to the further functional surface 50, the direction of inclination of which extends opposite of that of one of the transition cones 62, i.e. the further transition cone 68 widens upwards in the opposite direction. The fourth functional surface 66 merges into a fifth functional surface 70 at the inner peripheral end in the direction of the connected head part 18 or in the direction of the opened container opening 12, which fifth functional surface [has] a locking option for the withdrawal device 30 in the form of at least one threaded section 24 (FIGS. 1, 2 and 3) at its adjacent outer wall part 72 and [which is] shown only schematically in FIG. 4.

As cannot be seen in the view of FIG. 4, but which is shown in FIG. 2a, at least two webs 76 extend over the functional contact surface 44 and the additional lead-in area 50 at their adjacent outer wall areas or outer wall parts 54, 56, the free ends of which webs in each case merge integrally formed on the adjacent outer wall parts in the form of the respective transition cones 62, 68 into the associated area of the third and fourth functional surfaces 60 and 66. The webs 76 are used for axial bracing and for bracing in the circumferential direction and are, as shown in FIG. 2, located diametrically opposite from each other in relation to the longitudinal axis of the container 34 on the outside of the neck part 20. For ease of illustration, these webs 76 have been omitted in FIG. 1. As FIG. 3, which shows the container part 10 without contents 14 of the container, further illustrates further bracing webs 78 can be arranged in a vertical plane coplanar with the webs 76 on the outside of the container part 10. Such webs 78 are used to connect the individual container or the ampule as part of a conventional carton composite to further containers or ampules of a type in a row and in a common plane or orientation next to each other as merchandise (not shown) during manufacture, before any separation.

A further solution according to the invention is aimed at providing a device for producing a container according to FIGS. 1 to 4 or a connecting device, which uses a forming mandrel 80 as part of a molding plastic manufacturing process, which, in the form of a positive mold according to the illustration of FIGS. 5 and 6, forms at least two different shaping surfaces 82, 84, which in the course of the shaping process later correspond in terms of their design to the functional contact surface 44 or to the adjoining functional surface 50. In particular, the forming mandrel 80 can be used in the production of a container according to the embodiment according to FIGS. 1 to 4 as part of a conventional blow molding, filling and closing process (BFS or Bottelpack® process), which is described in more detail by way of example with reference to a corresponding production device according to DE 10 2014 001 446 A1.

As shown particularly in FIG. 6, the forming mandrel 80 is formed as a hollow mandrel and has the forming surface 82 on its underside, which forming surface later generates the 3.43 degree cone angle for the conical functional contact surface 44. In addition, the forming surface 82 is disposed on the outer circumference of the forming mandrel 80 which, viewed in the longitudinal axis 86 of the mandrel 80, forms a preferred cone angle of 30 degrees with the longitudinal axis or in the manner of a preferred 15 degree gradient. Above the molding surface 84, further molding surfaces 88 are arranged in superimposed arrangement as a third type of molding surfaces having different diameters, which are used to produce further functional surfaces 66, 70 in the neck part 20; which may optionally also be used for co-forming the head part 18.

The solution according to the invention has been explained in detail essentially with reference to lockable and non-lockable conical connections in accordance with ISO803669-7:2016, but can easily be transferred in an analogous manner to withdrawal devices/withdrawal bodies having other geometries, such as those for enteral (ISO 80369-3:2016) or neuraxial administration (ISO 80369-6:2016, including, but not limited to, spinal or epidural anesthesia and intrathecal chemotherapy).

The solution according to the invention provides a container or an ampule having a special connecting device or another connection device, which can be produced cost-effectively and reliably as part of a blow-fill-seal method, the BFS method. Low handling forces and/or handling torques are required to safely establish the connections for a transfer of a fluid, based on a standardized withdrawal body, below and above atmospheric pressure, wherein soft plastic materials such as polypropylene (PP) or polyethylene (HDPE, LDPE) can be used for the container without further ado.

1. A container, in particular an ampule, of plastic material having a container part (10) for receiving the contents of a containers (14) dispensed via a container opening (12), which is closed by a head part (18) that can be separated along a separation line (16,) which is adjoined by a neck part (20), which has a plurality of different functional surfaces on the inner circumference, of which one functional contact surface (44) is used to seal against a withdrawal body (32), which is provided for withdrawing the contents of a container (14) when the container opening (12) is opened, wherein in addition to the existing functional surfaces a lead-in area (50) is provided as a further functional surface on the interior of the neck part (40), which differs geometrically from the functional contact surface (44), characterized in that the lead-in area (50) seamlessly merges into the functional contact surface (44) and that the lead-in area (50) and the functional contact surface are accommodated between the other functional surfaces (44) in the neck part (20).

2. Container according to claim 1, characterized in that the differences in the geometric properties between the functional contact surface (44) and the lead-in area (50) in the
longitudinal extension and/or
wall thickness in conjunction with adjacent outer wall parts of the neck part and/or
the inclination of the surface.

3. The container according to claim 1, characterized in that at least part of the functional contact surface (44) exerts an increased sealing pressure on the inserted withdrawal body (32) for a reduced sealing surface.

4. The container according to claim 1, characterized in that a sealing effect between the container and a withdrawal body (32) inserted via the opened container opening (12) is achieved exclusively by the functional contact surface (44) of the neck part (20), wherein the functional contact surface (44) in the withdrawal position of the withdrawal body (32) in the neck part (20) at least partially abuts the outer surface of the withdrawal body (32) forming a sealing surface.

5. The container according to claim 1, characterized in that the mean wall thickness in the area of the lead-in area (50) and/or functional contact surface (44) in comparison to the mean wall thickness of the other functional surfaces (66, 70) is reduced by approx. 20%-50%, preferably approx. 20%-30% by including the adjacent outer wall parts (54, 56) towards the individual functional surfaces (44, 50).

6. The container according to claim 1, characterized in that the functional contact surface (44) has a contact cone having an opening angle of 0 to 10 degrees, preferably 2-5 degrees, particularly preferably 3 to 4 degrees.

7. The container according to claim 1, characterized in that the opening angle (α) of the additional cone-shaped lead-in area (50) is 10-40 degrees, preferably 20-40 degrees, particularly preferably 25-35 degrees.

8. The container according to claim 1, characterized in that the spacing (C) of the head end of the partial thread (26) from the opening (12) is not more than 2 mm, preferably less than 1 mm.

9. The container according to claim 1, characterized in that the distance (D) of the head end of the functional contact surface (44) from the opening (12) is more than 3 mm, preferably more than 4 mm, more preferably more than 5 mm, is.

10. The container according to claim 1, characterized in that a transition surface is used as a further third functional surface (60) on the inside of the neck part (20), which opens into the container part (10) and, starting from the contact surface (44), has an outwardly projecting transition cone (62).

11. The container according to claim 1, characterized in that a further transition cone (68) is provided with respect to the one transition cone (62) opposite direction of inclination as a further fourth functional surface (66) adjacent to the additional functional surface (50).

12. The container according to claim 1, characterized in that the fourth functional surface (66) merges into a fifth functional surface (70) in the direction of the head part (18), which fifth functional surface has a mounting (74) for the withdrawal device (30) at its adjacent, outer wall part (72).

13. The container according to claim 1, characterized in that the mounting (74) of the withdrawal device (30) on the outside of the neck part (20) is formed of at least one threaded section (24) in the manner of a female thread and that preferably the threaded section (24) is formed of at least two partial thread sections (26, 28), whose mean thread courses form an angle of approximately 70 to 80 degrees with the longitudinal axis (34) of the container.

14. The container according to claim 1, characterized in that at least two webs (76) extend over the functional contact surface (44) and the lead-in area (50) at their adjacent outer wall parts (54, 56), the free ends of which webs merge into the adjacent outer wall areas (54, 56) of the third and fourth functional surfaces (60, 66).

15. The container according to claim 1, characterized in that it is used for packaging fluids for enteral use.

16. The container according to claim 1, characterized in that it is used for packaging fluids for parenteral use.

17. The container according to claim 1, characterized in that it is used for packaging fluids for neuraxal use.

18. A device for producing a container according to claim 1, characterized in that a forming mandrel (80) is used as part of a molding plastic manufacturing process, which forming mandrel as a positive mold forms at least two molding surfaces (82, 84) in the form of the contact surface function (44) and in the form of the adjoining lead-in area (50).

19. The device according to claim 18, characterized in that the forming mandrel (84) is used to manufacture a container in the context of a blow molding, filling and closing process.
